(19) United States
(12) Patent Application Publication
(10) Pub. No.: US 2024/0340063 A1
(43) Pub. Date: Oct. 10, 2024

(54) SUBBAND CHANNEL STATE INFORMATION PAYLOAD REDUCTION IN A FULL-DUPLEX NETWORK

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Gokul SRIDHARAN, Sunnyvale, CA (US); Abdelrahman Mohamed Ahmed Mohamed IBRAHIM, San Diego, CA (US)

(21) Appl. No.: 18/296,780

(22) Filed: Apr. 6, 2023

(51) Int. Cl. H04B 7/06; H04L 5/00; H04W 72/21

(52) U.S. Cl. CPC H04B 7/066; H04B 7/0626; H04L 5/0057; H04W 72/21; H04L 5/14

(57) ABSTRACT

A user equipment (UE) receives a configuration of a first plurality of subbands having different sizes for channel state information (CSI) reporting. The configuration is for a bandwidth part configured for subband full duplexing with an uplink subband. A size of the subbands in the first plurality of subbands decreases closer in frequency to the uplink subband. The UE transmit a reduced CSI report payload including a plurality of CSI values, the reduced CSI report payload having fewer bits than a size of an absolute CSI value times a number of subbands in the first plurality of subbands. The UE may reduce the number of bits in the CSI report payload using differential CSI values instead of absolute CSI values, reporting CSI values for only a subset of the subbands, or using a fallback subband configuration with equal sized subbands.

### BACKGROUND

### Technical Field

The present disclosure relates generally to communication systems, and more particularly, to subband channel state information (CSI) payload reduction in a full-duplex network.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a non-transitory computer-readable medium, and an apparatus for a victim user equipment (UE) are provided. The method includes receiving, at the UE, a configuration of a first plurality of subbands having different sizes for channel state information (CSI) reporting. The method includes transmitting, from the UE, a reduced CSI report payload including a plurality of CSI values, the reduced CSI report payload having fewer bits than a size of an absolute CSI value times a number of subbands in the first plurality of subbands.

In some aspects, the techniques described herein relate to an apparatus for wireless communication, including: a transceiver; a memory storing computer-executable instructions; and a processor coupled with the transceiver and the memory and configured to execute the computer-executable instructions to cause the apparatus to: receive, at a user equipment (UE), a configuration of a first plurality of subbands having different sizes for CSI reporting; and transmit, from the UE, a reduced CSI report payload including a plurality of CSI values, the reduced CSI report payload having fewer bits than a size of an absolute CSI value times a number of subbands in the first plurality of subbands.

In some aspects, the techniques described herein relate to an apparatus for wireless communication, including: a transceiver; a memory storing computer-executable instructions; and a processor coupled with the transceiver and the memory and configured to execute the computer-executable instructions to cause the apparatus to: transmit, to a UE, a configuration of a first plurality of subbands having different sizes for CSI reporting; and receive, from the UE, a reduced CSI report payload having fewer bits than a size of an absolute CSI value times a number of subbands in the first plurality of subbands.

In some aspects, the techniques described herein relate to a method of wireless communication for a UE, including: receiving a configuration of subbands of different sizes for CSI reporting including a first group of subbands having a size greater than or equal to a threshold and a second group of subbands having a size less than the threshold; and transmitting a CSI value for each subband, each CSI value for the first group of subbands being an absolute CSI value and each CSI value for the second group of subbands being a differential CSI value.

In some aspects, the techniques described herein relate to a method of wireless communication for a UE, including: receiving a configuration of a plurality of subbands of different sizes for CSI reporting; measuring a CSI value for each of the plurality of subbands; determining that a configured condition for reduced CSI reporting is satisfied; and transmitting a CSI report including the CSI value for a subset of the subbands.

In some aspects, the techniques described herein relate to a method of wireless communication for a UE, including: receiving a configuration of a first plurality of subbands of different sizes for CSI reporting; measuring a CSI value for each of the first plurality of subbands; determining that a configured condition for reduced CSI reporting is satisfied; and transmitting a CSI report including a CSI value for each of a second plurality of subbands having an equal size, wherein a number of the second plurality of subbands is less than a number of the first plurality of subbands.

The present disclosure also provides an apparatus (e.g., a UE) including a memory storing computer-executable instructions and at least one processor configured to execute the computer-executable instructions to cause the apparatus to perform the above method, an apparatus including means for performing the above method, and a non-transitory computer-readable medium storing computer-executable instructions for performing the above method.

In another aspect, the disclosure provides a method, a non-transitory computer-readable medium, and an apparatus for a base station. The method includes transmitting, to a UE, a configuration of a first plurality of subbands having different sizes for CSI reporting. The method includes receiving, from the UE, a reduced CSI report payload having fewer bits than a size of an absolute CSI value times a number of subbands in the first plurality of subbands.

The present disclosure also provides an apparatus (e.g., network node such as a base station) including a memory storing computer-executable instructions and at least one processor configured to execute the computer-executable instructions to cause the apparatus to perform the above method, an apparatus including means for performing the above method, and a non-transitory computer-readable medium storing computer-executable instructions for performing the above method.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system including an access network, in accordance with certain aspects of the present description.

FIG. 2A is a diagram illustrating an example of a first frame, in accordance with certain aspects of the present description.

FIG. 2B is a diagram illustrating an example of downlink (DL) channels within a subframe, in accordance with certain aspects of the present description.

FIG. 2C is a diagram illustrating an example of a second frame, in accordance with certain aspects of the present description.

FIG. 2D is a diagram illustrating an example of uplink (UL) channels within a subframe, in accordance with certain aspects of the present description.

FIG. 3 is a diagram illustrating an example of a base station and user equipment (UE) in an access network, in accordance with certain aspects of the present description.

FIG. 4 is a resource diagram illustrating available UL resources for different slot types including a slot with subband full duplex (SBFD) symbols, in accordance with certain aspects of the present description.

FIG. 5 is a diagram illustrating an example of a subband configuration for channel state information (CSI) reporting.

FIG. 6 is a diagram illustrating an example of a subband configuration for CSI reporting with different sized subbands, in accordance with certain aspects of the present description.

FIG. 7 is a diagram illustrating an example of payload reduction for CSI reporting using absolute and relative CSI values, in accordance with certain aspects of the present description.

FIG. 8 is a diagram illustrating an example of payload reduction for CSI reporting using a subset of subbands, in accordance with certain aspects of the present description.

FIG. 9 is a diagram illustrating an example of payload reduction for CSI reporting using a fallback subband configuration, in accordance with certain aspects of the present description.

FIG. 10 is a message diagram illustrating example messages for CSI reporting with a reduced CSI report payload.

FIG. 11 is a conceptual data flow diagram illustrating the data flow between different means/components in an example BS, in accordance with certain aspects of the present description.

FIG. 12 is a conceptual data flow diagram illustrating the data flow between different means/components in an example UE, in accordance with certain aspects of the present description.

FIG. 13 is a flowchart of an example method for a UE to report CSI with a reduced CSI report payload.

FIG. 14 is a flowchart of an example method for a base station to receive a CSI report with a reduced CSI report payload, in accordance with certain aspects of the present description.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. Although the following description may be focused on 5G NR, the concepts described herein may be applicable to other similar areas, such as LTE, LTE-A, CDMA, GSM, and other wireless technologies.

Full duplex communication may allow a wireless communication device to transmit and receive at the same time. In-band full duplex (IBFD) may refer to transmission and reception on the same time and frequency resource. The uplink (UL) and the downlink (DL) may share the same IBFD time and frequency resource, which may include fully overlapping resources or partially overlapping resources. Subband frequency division duplexing (SBFD) may refer to transmission and reception at the same time on different frequency resources. The DL resource may be separated from the UL resource in the frequency domain by a guard gap. For example, an UL subband may be configured as the UL resource for SBFD. The UL subband may be located in the middle of a DL resource to separate the UL transmission from adjacent frequency resources.

A resource element (RE) may refer to a basic unit of resources that is one sub-carrier on one symbol. REs may be grouped into resource blocks (RBs) in a symbol for scheduling. In some cases, a SBFD-capable UE may be configured for SBFD on the UL subband in some time-domain resources such as slots or symbols. For example, a slot may be configured as DL, UL, or SBFD. Any symbols in an SBFD slot may be considered SBFD symbols. Similarly, one or more symbols within a slot (e.g., a DL slot) may be designated as SBFD symbols. SBFD symbols may provide flexibility in scheduling a physical UL channel such as a physical uplink control channel (PUCCH) or physical uplink shared channel (PUSCH) from the SBFD-aware UE. For instance, a UE may be able to transmit in a DL slot on SBFD symbols rather than waiting for an UL slot or symbol.

An SBFD configuration may impact channel state information (CSI) reporting. CSI reporting may be configured as wide band or subband. In subband reporting, the bandwidth part may be divided into a plurality of subbands and a UE may report a CSI value for each subband. For example, the CSI reporting values may include channel quality indicator (CQI), precoding matrix indicator (PMI), rank indicator (RI), CSI-RS Resource Indicator (CRI), SS/PBCH Resource Block Indicator (SSBRI), layer indicator (LI), and layer 1 reference signal received power (L1-RSRP). Subband reporting may use more resources than wide band reporting.

For an SBFD configuration, the channel conditions closer in frequency to the uplink subband may experience leakage from the uplink subband. Accordingly, channel conditions closer in frequency to the uplink subband may differ significantly from channel conditions further in frequency from the uplink subband. Subband reporting of CSI may be useful in capturing these differences so that the network can appropriately schedule a UE, especially on the resources closer in frequency to the uplink subband.

In an aspect, subband CSI reporting for SBFD may utilize different sized subbands. Conventional subband configurations for CSI reporting specify a single size for each subband except for a final subband if the bandwidth part is not evenly divisible. For an SBFD configuration where channel conditions vary near the uplink subband, it may be desirable to have smaller subbands near the uplink subband and larger subbands further in frequency from the uplink subband. Such a subband configuration may allow the subband CSI report to capture the changes in channel conditions close to the uplink subband, so that the network can effectively schedule those resources.

A subband configuration with different sized subbands may increase the number of subbands to report, in particular, if multiple smaller subbands are configured near the uplink subband. In some cases, for example, where a PUCCH resource is used for transmitting the CSI report, the size of the CSI report may exceed the available resources for transmission. Accordingly, there is a need for reducing a size of a subband CSI report payload in a full-duplex network.

In an aspect, the present disclosure provides for a user equipment (UE) to reduce a size of a payload for a subband CSI report, at least under configured conditions. The UE may receive a configuration of a first plurality of subbands having different sizes for CSI reporting. For example, as discussed above, the subbands closer in frequency to an uplink subband may have a smaller size (e.g., number of resource blocks) than the subbands further in frequency from the uplink subband. The UE may transmit a reduced CSI report payload that includes fewer bits than a size of an absolute CSI value times a number of subbands in the first plurality of subbands. In some implementations, the reduced CSI report payload may be transmitted when a configured condition is satisfied. For example, the configuration of the first plurality of subbands may indicate that a reduced CSI report payload is to be transmitted when the size of the payload would exceed the available resources for the CSI transmission. The reduced CSI report payload may include relative CSI values instead of absolute CSI values, include the CSI values for only a subset of the subbands, or include CSI values for a second set of subbands having the same size.

Particular implementations of the subject matter described in this disclosure can be implemented to realize one or more of the following potential advantages. A reduced CSI report payload may allow transmission of CSI on resources that are insufficient for transmission of a full CSI report. A reduced CSI report payload may be transmitted with lower power than a full CSI report. Additionally, the reduced CSI report may still provide sufficient information for the network to schedule the UE on subbands near the uplink subband.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software (e.g., computer-executable instructions). The execution of the computer-executable instructions may cause an apparatus to perform the functions described herein. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code (e.g., computer-executable instructions) on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

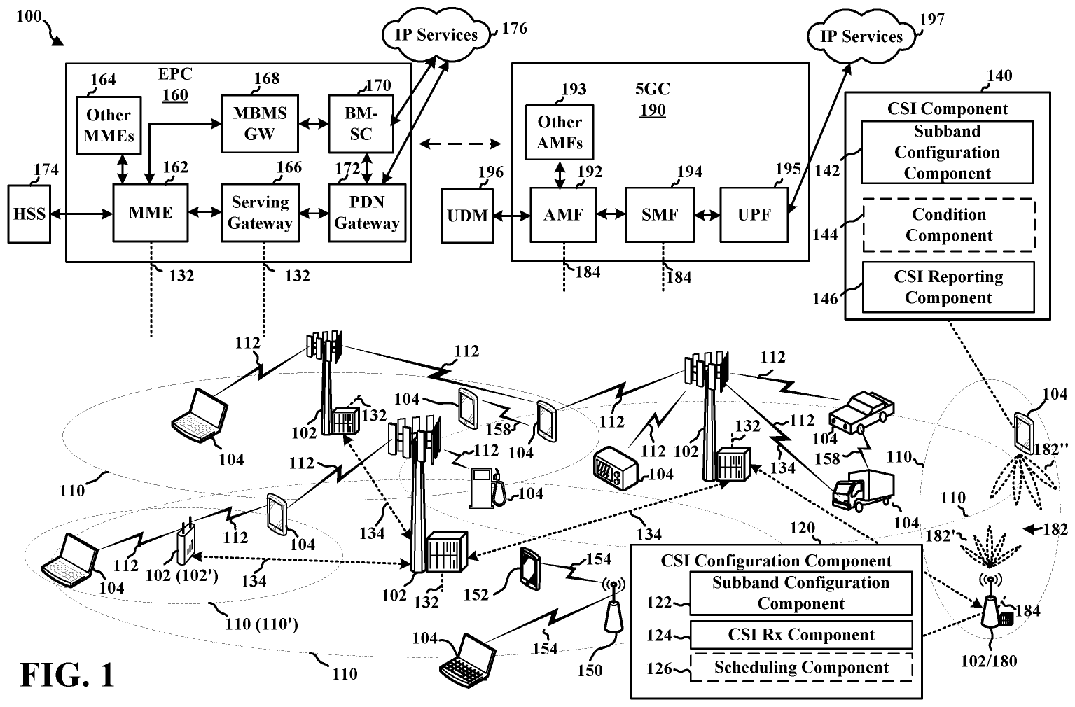

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network (e.g., a 5G Core (5GC) 190). The base stations 102 may include macrocells (high power cellular base station) and/or small cells (low power cellular base station). The macrocells include base stations. The small cells include femtocells, picocells, and microcells.

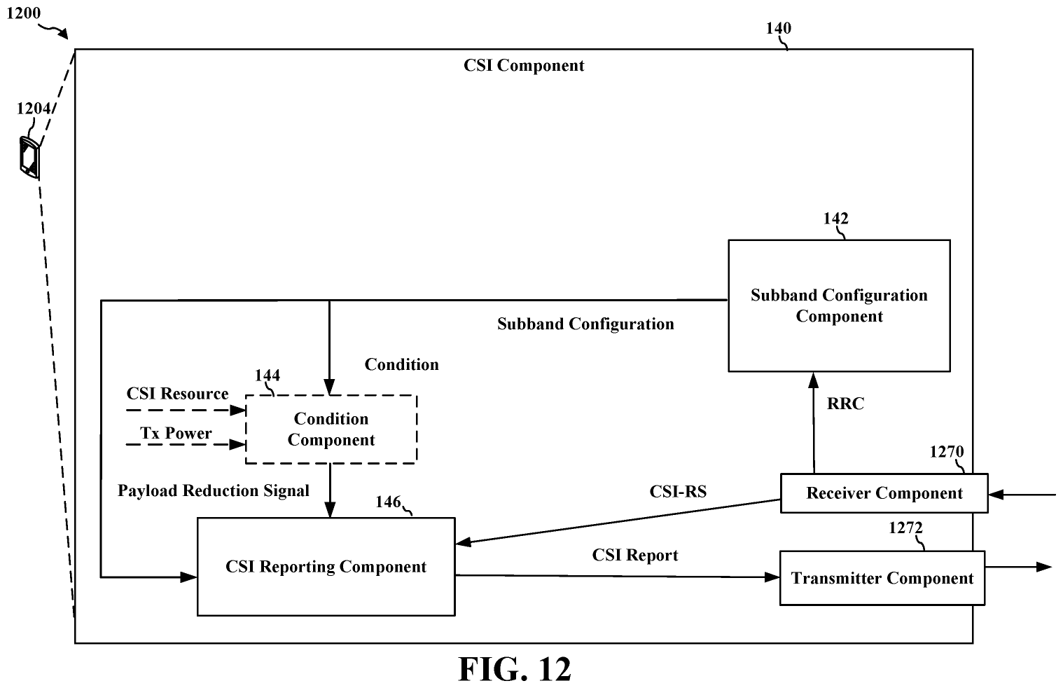

In an aspect, one or more of the UEs 104 may include a CSI component 140 configured to transmit a CSI report. The CSI component 140 includes a subband configuration component 142 configured to receive at the UE, a configuration of a first plurality of subbands having different sizes for CSI reporting. In some implementations, the CSI component 140 may include a condition component 144 configured to determine whether a condition for reduced CSI report payload indicated by the configuration is satisfied. The CSI component 140 includes a CSI reporting component 146 configured to transmitting, from the UE, a reduced CSI report payload having fewer bits than a size of an absolute CSI value times a number of subbands in the first plurality of subbands. Additional components of the UE 104 and the CSI component 140 are illustrated in FIG. 12.

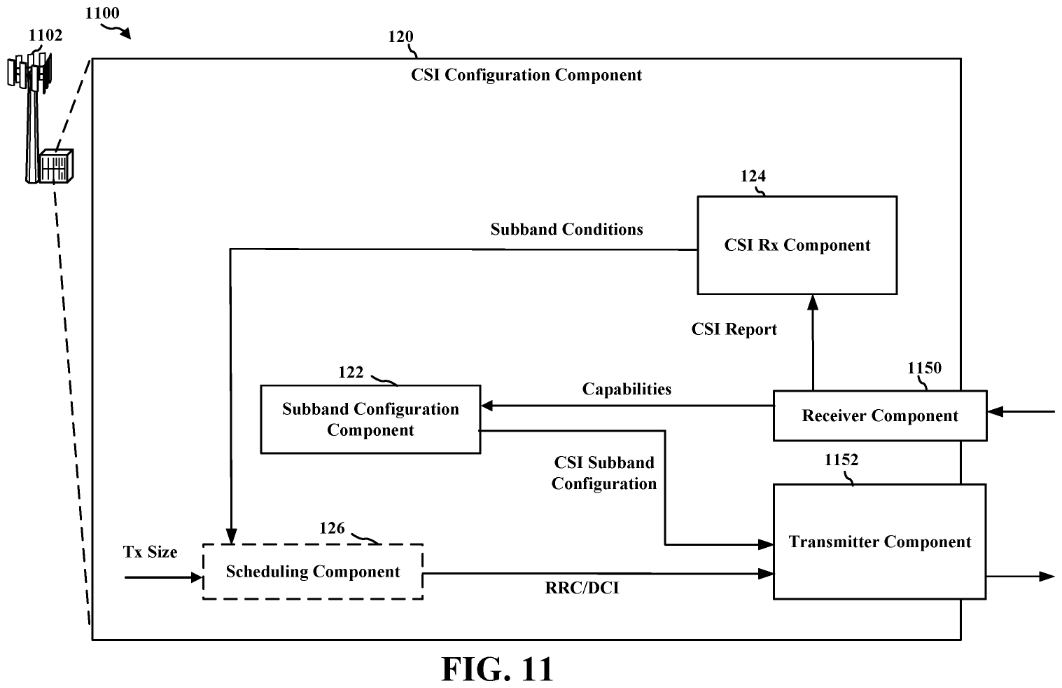

In an aspect, one or more of the base stations 102 may include a CSI configuration component 120 that performs the actions of the base station as described herein. For example, the CSI configuration component 120 may include a subband configuration component 122 configured to transmit, to a UE, a configuration of a first plurality of subbands having different sizes for CSI reporting. The CSI configuration component 120 may include an CSI receiving (Rx) component 124 configured to receive, from the UE, a reduced CSI report payload having fewer bits than a size of an absolute CSI value times a number of subbands in the first plurality of subbands. In some implementations, the CSI configuration component 120 may include a scheduling component 126 configured to schedule the UE to receive one or more transmissions based on the CSI report. Additional components of the base station 102 and CSI configuration component 120 are illustrated in FIG. 11.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The backhaul links 132 may be wired or wireless. The base stations 102 configured for 5G NR (collectively referred to as Next Generation RAN (NG-RAN)) may interface with 5GC 190 through backhaul links 184. The backhaul links 184 may be wired or wireless. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 112 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 112 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and a physical sidelink feedback channel (PSFCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the 5GC 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

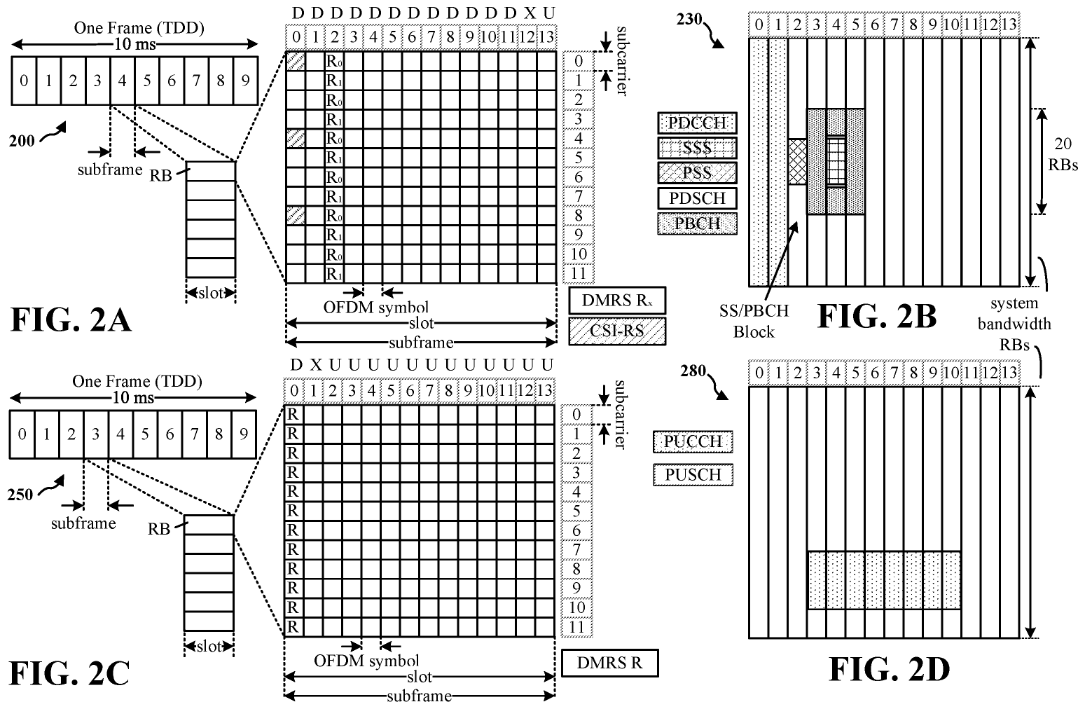

FIGS. 2A-2D are resource diagrams illustrating example frame structures and channels that may be used for UL, DL, and sidelink transmissions to a UE 104 including a CSI component 140. FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology p, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical UL control channel (PUCCH) and DM-RS for the physical UL shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries UL control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

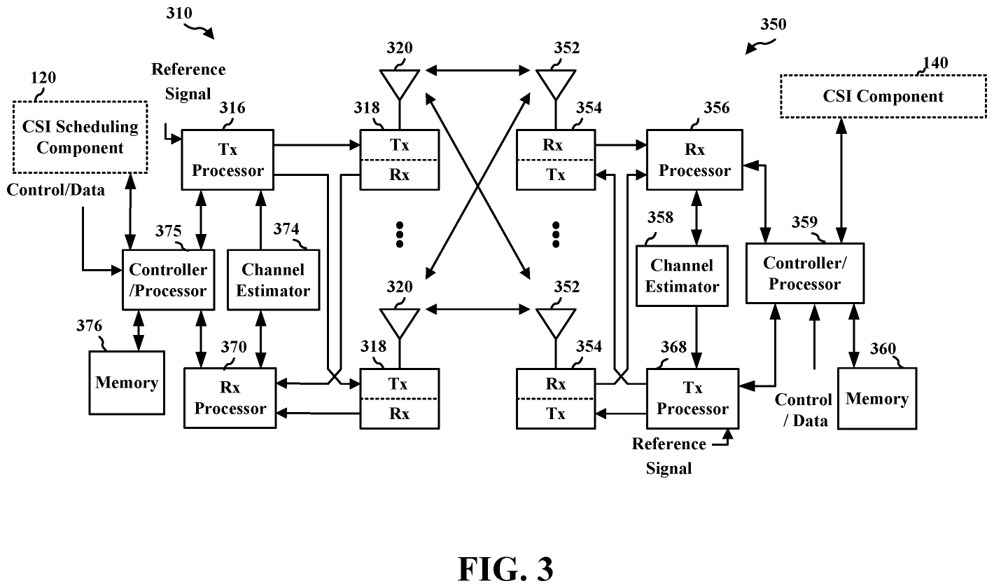

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate an RF carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160 or 5GC 190. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the Tx processor 368, the Rx processor 356, and the controller/processor 359 may be configured to perform aspects in connection with the CSI component 140 of FIG. 1. For example, the memory 360 may include executable instructions defining the CSI component 140. The TX processor 368, the RX processor 356, and/or the controller/processor 359 may be configured to execute the CSI component 140.

At least one of the Tx processor 316, the Rx processor 370, and the controller/processor 375 may be configured to perform aspects in connection with the CSI configuration component 120 of FIG. 1. For example, the memory 376 may include executable instructions defining the CSI configuration component 120. The TX processor 316, the RX processor 370, and/or the controller/processor 375 may be configured to execute the CSI configuration component 120.

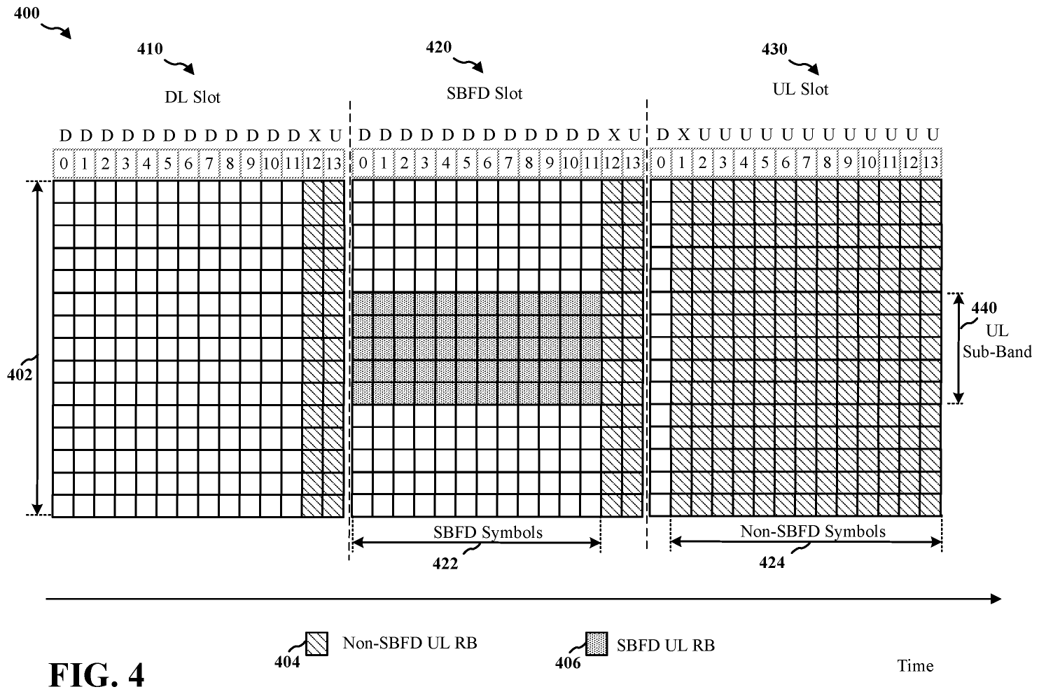

FIG. 4 is a resource diagram 400 illustrating available UL resources for different slot types. A bandwidth part 402 may include a number of RBs. A SBFD configuration may indicate an UL subband 440 and time-domain resources that are configured for SBFD. Generally, the UL subband 440 is located near the middle of the bandwidth part 402 such that the UL subband 440 is separated from other frequency domain resources by DL subbands. It should be understood that number of RBs in the bandwidth part 402 and the UL subband 440 is merely illustrative and that larger or smaller numbers may be configured.

The UL resources may include SBFD UL RBs 406 on SBFD symbols 422 and non-SBFD UL RBs 404 on non-SBFD symbols 424, which include flexible (X) symbols and uplink (U) symbols. The SBFD symbols 422 may be DL symbols or X symbols configured with an UL subband 440. Accordingly, only the SBFD UL RBs 406 located in the UL subband 440 may be used for UL transmission in the SBFD symbols 422.

Slot 410 is a DL-centric slot (e.g., slot format 34) without SBFD configuration. Only symbols 12 and 13 may be used for UL transmission. Slot 430 is an UL-centric slot (e.g., slot format 28), where symbols 1-13 may be used for UL transmission.

Slot 420 is an SBFD slot. Although slot 420 has the same slot format as the slot 410, slot 420 is configured for SBFD using the UL subband 440. Accordingly, in slot 420, the SBFD symbols 422 may be used for UL transmission on the SBFD UL RBs and for DL transmission on the rest of the RBs.

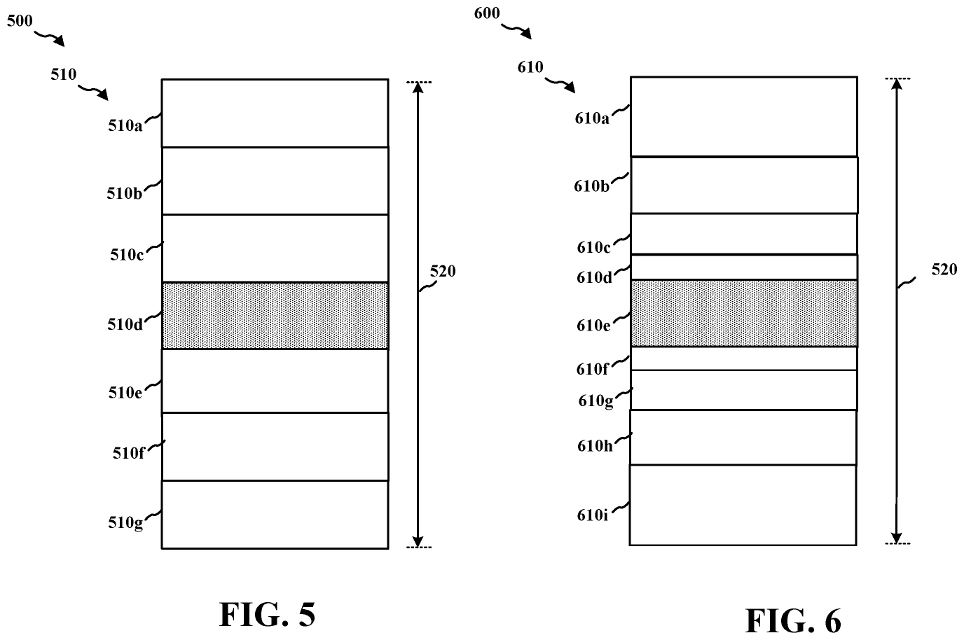

FIG. 5 is a resource diagram illustrating an example of a subband configuration 500 for CSI reporting. The subband configuration 500 may include subbands 510 (e.g., subbands 510a-510g) within a bandwidth part 520. Each of the subbands 510 may be the same size (e.g., the same number of RBs). For example, the subband size may be configurable between 4 and 32 PRBs based on a total number of PRBs in the bandwidth part 520. In some implementations, where the subband configuration 500 is used for SBFD symbols 422 (FIG. 4), the UL subband 440 may correspond to the subband 510d, for example.

In some implementations, a UE may report one or more CSI values for each subband 510. For example, the UE may be configured with a report quantity parameter that indicates which CSI quantities to include in the CSI report. For example, the report quantity parameter may indicate one or more of CQI, PMI, RI, CRI, SSBRI, LI, and L1-RSRP. In an aspect, where subband CSI reporting is configured, a CSI report payload may include a value for each indicated CSI quantity for each subband 510. The value for each CSI quantity may be represented by a number of bits. For example, the CQI quantity may be an absolute value represented by 4 bits or a relative value represented by 2 bits. The use of relative values may trade off precision for a smaller payload.

FIG. 6 is a resource diagram illustrating an example of a subband configuration 600 for CSI reporting with different sized subbands 610. The subband configuration 600 may be an alternative configuration for the bandwidth part 520. For example, the subband configuration 600 may be used when the UE is configured with SBFD. In the illustrated example, an uplink subband 610e (e.g., correspond to uplink subband 440) may be located in the middle of the bandwidth part 520. The subbands closest in frequency to the uplink subband 610e may be smaller than the subbands further from the uplink subband 610e. For example, the subbands 610d and 610f may be 2 RBs, the subbands 610c and 610g may be 4 RBs, the subbands 610b and 610h may be 8 RBs, and the subbands 610a and 610i may be 16 RBs.

In some implementations, the subband configuration 600 may include more subbands than the subband configuration 500. The additional subbands may allow finer granularity in reporting the channel information, particularly near the uplink subband 610e, where leakage from the uplink subband 610e may affect the channel conditions. The increase in the number of subbands, however, may also increase a size of a CSI report payload as each report quantity is reported for each of the subbands 610. In some implementations, where the CSI report is transmitted on a PUCCH resource, for example, the size of the CSI report may be too big for the PUCCH resource.

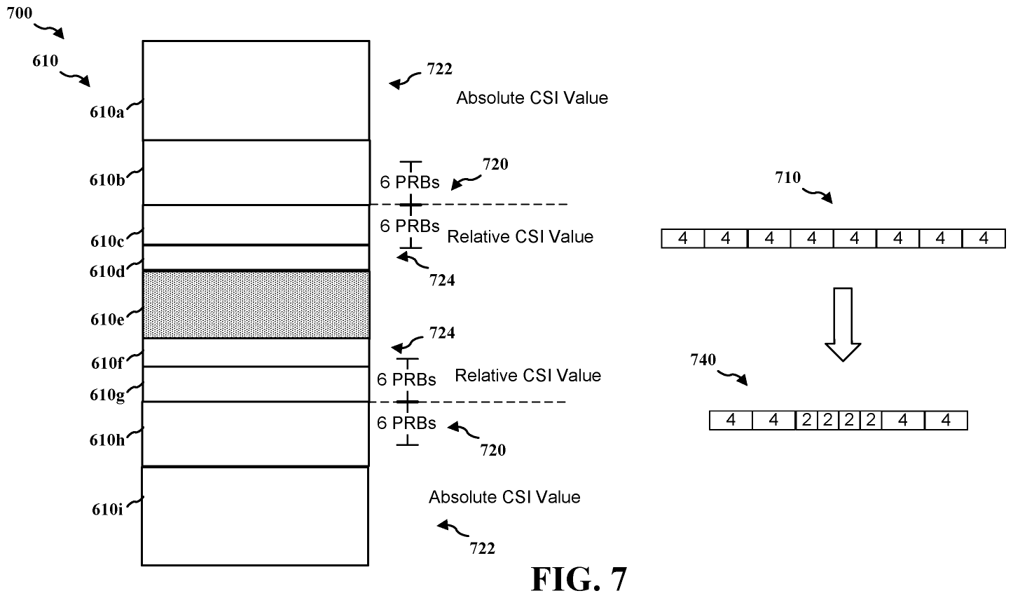

FIG. 7 is a diagram 700 illustrating an example of payload reduction for CSI reporting using absolute and differential CSI values. Payload reduction may be applicable to CSI reporting based on a subband configuration 600. In some implementations, for example, the UE may not report a value for the uplink subband 610e. In the illustrated example, if only a CQI quantity is configured for reporting as the absolute value, a full CSI report payload 710 may include 4 bits for each of the subbands 610a-610d and 610f-610i for a total size of 32 bits.

In an aspect, the UE may be configured with a threshold 720. The threshold 720 may be a threshold size for reporting an absolute CSI value. For example, the threshold 720 may be expressed as a number of PRBs or a frequency range. If the size of the subband 610 is greater than the threshold 720, the UE may report an absolute value for the subband 610. For example, the absolute value for a CQI quantity may be 4 bits. If the size of the subband 610 is less than the threshold 720, the UE may report a differential value for the subband 610. For example, the differential value for a CQI quantity may be 2 bits indicating a change from a wideband CQI value. In the illustrated example, the threshold 720 may be 6 PRBs. The subbands 610c, 610d, 610f, and 610g may have sizes smaller than the threshold 720 and a CSI value (e.g., CQI value) may be reported using a 2-bit differential value rather than the 4-bit absolute value. The subbands 610a, 610b, 610h, and 610i may have a size greater than the threshold 720 and may be reported using the 4-bit absolute value. Accordingly, a reduced CSI report payload 740 may have a total size of 24 bits.

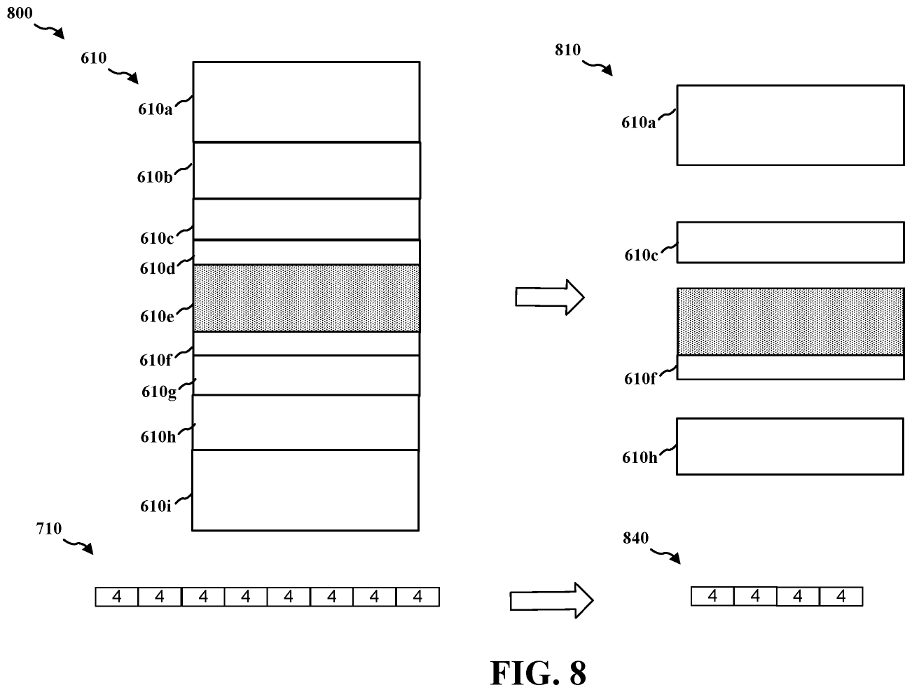

FIG. 8 is a diagram 800 illustrating an example of payload reduction for CSI reporting using a subset 810 of subbands in the subband configuration 600. Payload reduction may be applicable to CSI reporting based on a subband configuration 600. In some implementations, for example, the UE may not report a value for the uplink subband 610e. In the illustrated example, if only a CQI quantity is configured for reporting as the absolute value, an initial CSI payload may include 4 bits for each of the subbands 610a-610d and 610f-610i for a total size of 32 bits.

In some implementations, the configuration 600 may include a condition for transmitting a reduced CSI payload. One example condition that may be indicated by the configuration 600 is that a PUCCH resource size is insufficient to transmit the full CSI report payload 710 having a size of the absolute CSI value times the number of the subbands in the first plurality of subbands. Another example condition may be based on a transmit power of the UE. For example, the UE may transmit a reduced CSI report payload when the UE is in a power limited state.

When the condition is satisfied, the UE may transmit a reduced CSI report payload 840 including CSI values for a subset of the configured subbands 610. As used herein, a “subset of the subbands” refers to a set of subbands including fewer than the number of subbands configured for CSI reporting. For example, as illustrated in FIG. 8, there are 8 subbands configured for CSI reporting in the full CSI report payload 710. The uplink subband 610e may not be configured for CSI reporting. In some implementations, the subset 810 may be indicated by a bitmap in the subband configuration that indicates for which subbands to include the CSI value in the reduced CSI report payload 840. For instance, the bitmap may indicate subbands 610a, 610c, 610f, and 610h. In other implementations, the subset 810 may be indicated by a configured to pre-defined pattern. For example, a standards document or regulation may define a pattern for the subset 810. For instance, a pre-defined pattern may indicate every other subband 610. In some implementations, the pattern may be configurable, for example, a configuration parameter N may indicate every Nth subband 610. In the illustrated example, the subset 810 including 4 subbands 610 may reduce the size of the reduced CSI report payload to 16 bits.

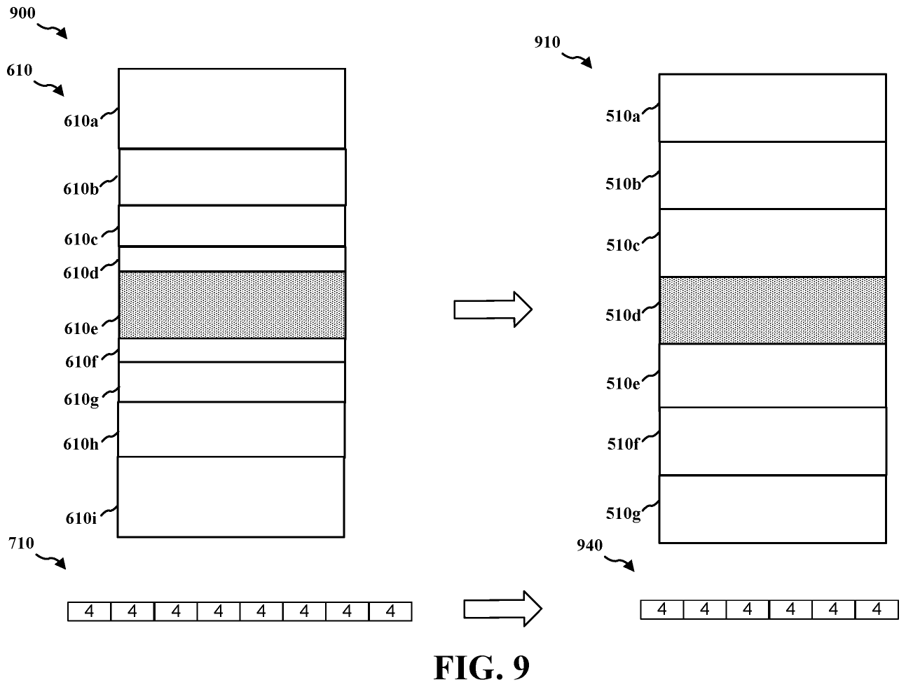

FIG. 9 is a diagram 900 illustrating an example of payload reduction for CSI reporting using a fallback subband configuration 910. Payload reduction may be applicable to CSI reporting based on a subband configuration 600. In some implementations, for example, the UE may not report a value for the uplink subband 610e. In the illustrated example, if only a CQI quantity is configured for reporting as the absolute value, the full CSI report payload 710 may include 4 bits for each of the subbands 610a-610d and 610f-610i for a total size of 32 bits.

As discussed above with respect to FIG. 8, the configuration 600 may include a condition for transmitting a reduced CSI payload. The condition may also be applicable to the fallback subband configuration 910. The fallback subband configuration 910 may have subbands with equal sizes. For example, the fallback subband configuration 910 may be similar to the subband configuration 500 including subbands 510. For example, the subbands 510 may have an equal size, e.g., 10 RB. The number of subbands 510 may be less than the number of subbands 610. For instance, in the illustrated example, the subbands 610a-610d and 610f-610i may include 8 subbands covering a total of 60 RBs whereas the subbands 510a-510c and 510e-510f may include 6 subbands covering a total of 60 RBs. The reduced CSI report payload 940 may include 6 values (e.g., 4-bit absolute CQI values) for a total of 24 bits.

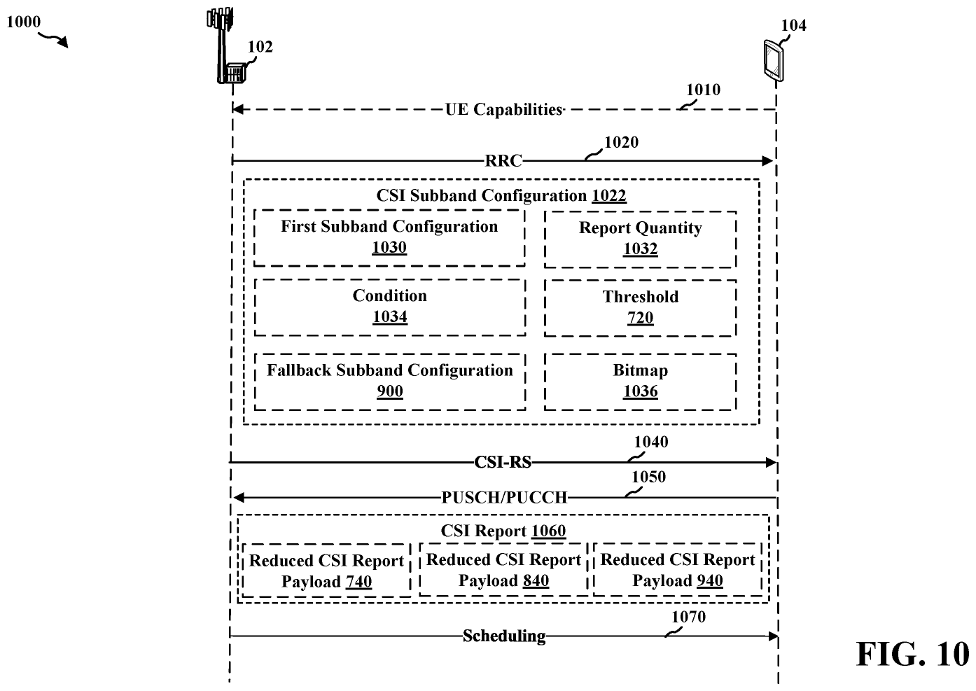

FIG. 10 is a message diagram 1000 illustrating example messages for configuration and transmission of CSI reports with a reduced CSI report payload. A base station 102 may be a serving base station for a UE 104. The UE 104 may transmit UE capabilities 1010 indicating a capability of the UE 104 for SBFD, different sized subbands, and/or reduced CSI payload reporting.

The base station 102 may configure the UE 104 with a CSI subband configuration 1022. For example, the base station 102 may transmit the CSI subband configuration 1022 via RRC signaling 1020. The CSI subband configuration 1022 may include, for example, a first subband configuration 1030 for a first plurality of subbands having different sizes for CSI reporting. For example, the first subband configuration 1030 may correspond to the subband configuration 600. In some implementations, the first subband configuration 1030 may specify a size for each subband or specify parameters for determining the size for each subband. For instance, the parameters may include a size of the subbands closest to the uplink subband 610e and a multiplication factor used to determine the size of other subbands (e.g., 2). The CSI subband configuration 1022 may also include a report quantity 1032 indicating which CSI quantities to include in a CSI report. The CSI subband configuration 1022 may also include a condition 1034 for reduced CSI report payload transmission. In some implementations, the CSI subband configuration 1022 may include a threshold 720 that divides the subbands of the first subband configuration 1030 into a first group of subbands having a size greater than or equal to the threshold 720 and a second group of subbands having a size less than the threshold 720. In some implementations, the CSI subband configuration 1022 may include a fallback subband configuration 910 that defines a second plurality of subbands (e.g., subbands 510) having an equal size. A number of the second plurality of subbands is less than a number of the first plurality of subbands. In some implementations, the CSI subband configuration 1022 includes a bitmap 1036 that indicates for which subbands to include the CSI value in the reduced CSI report payload.

The base station 102 may transmit a CSI-RS 1040 that the UE 104 may measure to determine the configured CSI quantities for each configured subband.

The UE may transmit a PUSCH/PUCCH 1050 carrying a CSI report 1060. The PUSCH/PUCCH 1050 may be allocated resources for the CSI report 1060. In some implementations, the allocated resources may not be sufficient for the UE 104 to transmit a full CSI report including all of the configured report quantities for each of the configured subbands. The CSI report 1060 may include a reduced CSI report payload 740, 840, or 940 as discussed above regarding FIGS. 7-9. The reduced CSI report payloads 740, 840, or 940 may include fewer bits than a full CSI report payload, and may allow for transmission on the PUSCH/PUCCH 1050 with insufficient resources.

In some implementations, the base station 102 may transmit scheduling 1070 to schedule the UE to receive one or more transmissions based on the CSI report. For example, the scheduling 1070 may include an RRC configuration of semi-persistent scheduling or a DCI with a dynamic grant. The scheduling 1070 may include parameters such as a frequency domain resource allocation (FDRA), time domain resource allocation (TDRA), and a modulation and coding scheme (MCS) that is selected based on the CSI report. For instance, the base station 102 may select and MCS and sufficient frequency resources such that the reported CQI values of the CSI report 1060 would support likely reception of a downlink transmission using the MCS on the selected resources.

FIG. 11 is a conceptual data flow diagram 1100 illustrating the data flow between different means/components in an example base station 1102, which may be an example of the base station 102 including the CSI configuration component 120. The CSI configuration component 120 includes the subband configuration component 122 and the CSI Rx component 124. The CSI configuration component 120 may optionally include a scheduling component 126.

The base station 1102 may include a receiver component 1150 and a transmitter component 1152. The receiver component 1150 may include, for example, a RF receiver for receiving the signals described herein. The transmitter component 1152 may include for example, an RF transmitter for transmitting the signals described herein. In some implementations, the receiver component 1150 and the transmitter component 1152 may be co-located in a transceiver such as the Tx/Rx 318 in FIG. 3.

The receiver component 1150 may receive UL signals from one or more UEs 104. For example, the receiver component 1150 may receive UE capabilities 1010, the PUSCH/PUCCH 1050 including the CSI report 1060. The receiver component 1150 may provide the UE capabilities 1010 to the subband configuration component 122. The receiver component 1150 may provide the PUSCH/PUCCH to the CSI Rx component 124.

The subband configuration component 122 may be configured to transmit, to a UE 104, a configuration of a first plurality of subbands having different sizes for CSI reporting. The subband configuration component 122 may receive capabilities 1010 for the UE 104 via the receiver component 1150. For instance, the capabilities 1010 may indicate a capability for SBFD, a capability for different sized subbands, and/or a capability for a reduced CSI report payload. The subband configuration component 122 may determine to configure the UE 104 with the first plurality of subbands having different sizes and reduced CSI report payloads based on the capabilities 1010. The subband configuration component 122 may generate the CSI subband configuration 1022. The CSI subband configuration 1022 may be applicable to both SBFD symbols 422 and to non-SBFD symbols 424. The subband configuration component 122 may transmit the subband configuration 1022 to the UE 104 via the transmitter component 1152.

The CSI Rx component 124 may be configured to receive from the UE 104 via the receiver component 1150, a reduced CSI report payload having fewer bits than a size of an absolute CSI value times a number of subbands in the first plurality of subbands. In some implementations, the base station 102 and/or the CSI configuration component 120 may not know whether the CSI report 1060 includes a full CSI report payload or a reduced CSI report payload, for example, because the reduced size may be based on a condition determined at the UE 104. The CSI Rx component 124 may determine whether the CSI payload is a reduced CSI report payload 740, 840, or 940 based on the size of the received payload being smaller than a size of a full CSI report payload. The CSI Rx component 124 may parse the reduced CSI report payload 740, 840, or 940 based on the subband configuration 1022 to determine the received CSI values. The CSI Rx component 124 may determine subband conditions based on the received CSI values. The CSI Rx component 124 may provide the subband conditions to the scheduling component 126.

The scheduling component 126 may be configured to schedule the UE for a downlink transmission on at least one subband of the plurality of subbands based on the CSI report. For example, the scheduling component 126 may receive the subband conditions from the CSI Rx component 124 based on the CSI report. In some implementations, the scheduling component 126 may receive a transmission size from higher layers. The scheduling component 126 may determine resources for transmitting a packet of the transmission size based on the subband conditions. For example, the scheduling component 126 may determine whether each of subbands 610 can support a desired MCS based on a CQI value reported for each subband. In some implementations, where the reduced CSI report payload does not include a value for a subband, the scheduling component 126 may estimate a value (e.g., via interpolation) based on the CQI values reported for other subbands, or the scheduling component 126 may use only subbands having reported CSI values. The scheduling component 126 may generate a scheduling message such as an RRC message or DCI for transmission via the transmitter component 1152.

FIG. 12 is a conceptual data flow diagram 1200 illustrating the data flow between different means/components in an example UE 1204, which may be an example of the UE 104 and include the CSI component 140.

As discussed with respect to FIG. 1, the CSI component 140 may include the subband configuration component 142 and the CSI reporting component 146. The CSI configuration component 120 may optionally include the condition component 144.

The UE 104 also may include a receiver component 1270 and a transmitter component 1272. The receiver component 1270 may include, for example, a RF receiver for receiving the signals described herein. The transmitter component 1272 may include for example, an RF transmitter for transmitting the signals described herein. In some implementations, the receiver component 1270 and the transmitter component 1272 may be co-located in a transceiver such as the TX/RX 354 in FIG. 3.

The receiver component 1270 may receive DL signals such as the RRC signaling 1020, the CSI-RS 1040, and the scheduling 1070. The receiver component 1270 may provide the RRC signaling 1020 to the subband configuration component 142. The receiver component 1270 may provide the CSI-RS 1040 to the condition component 144 and/or the CSI reporting component 146. The receiver component 1270 may schedule further receptions based on the scheduling 1070.

The subband configuration component 142 is configured to receive, via the receiver component 1270, a configuration of a first plurality of subbands having different sizes for CSI reporting. For example, the subband configuration component 142 may receive the RRC signaling 1020 via the receiver component 1270. The subband configuration component 142 may parse the RRC signaling 1020 to determine the CSI subband configuration 1022 including one or more of the parameters such as the first subband configuration 1030, the report quantity 1032, the condition 1034, the threshold 720, the fallback subband configuration 910, or the bitmap 1036. The subband configuration component 142 may provide the subband configuration to the CSI reporting component 146 and/or the condition component 144. In particular, when the subband configuration 1030 includes the condition 1034, the subband configuration component 142 may provide the condition 1034 to the condition component 144.

The condition component 144 may be configured to determine whether a condition for reduced CSI report payload transmission is satisfied. The condition component 144 may receive a configured condition 1034 from the subband configuration component 142. In some implementations, the condition component 144 may receive CSI report scheduling information such as a CSI resource or Tx power from an uplink scheduler. The condition component 144 may evaluate the condition 1034 based on the CSI report scheduling information. For instance, in some implementations, the condition is that a PUCCH resource size is insufficient to transmit a full CSI report payload having a size of the absolute CSI value times the number of the subbands in the first plurality of subbands. For example, referring back to FIG. 8, if the PUCCH resource size cannot support a 32-bit payload for the full CSI report payload 710, the condition component 144 may determine that the condition for reduced CSI report payload transmission is satisfied. As another example, if the Tx power is less than a threshold for the size of the full CSI report payload 710, the condition component 144 may determine that the condition for reduced CSI report payload transmission is satisfied. The condition component 144 may provide a payload reduction signal to the CSI reporting component 146 when the condition for reduced CSI report payload transmission is satisfied.

The CSI reporting component 146 is configured to transmit, from the UE, a reduced CSI report payload 740, 840, 940 having fewer bits than a size of an absolute CSI value times a number of subbands in the first plurality of subbands (e.g., full CSI report payload 710). The CSI reporting component 146 may receive the subband configuration 1030 from the subband configuration component 142. The CSI reporting component 146 may receive the CSI-RS 1040 from the base station 102 via the receiver component 1270. The CSI reporting component 146 may determine a CSI value for each subband 610 based on the subband configuration 1030 and the CSI-RS 1040. In some implementations, the CSI reporting component 146 may receive a payload reduction signal from the condition component 144 indicating to transmit the reduced CSI report payload 740, 840, 940. The CSI reporting component 146 may determine the reduced CSI report payload 740, 840, 940 based on the subband configuration 1030 and the CSI-RS as discussed above regarding FIGS. 7-9. The CSI reporting component 146 may generate a CSI report including the reduced CSI report payload 740, 840, 940 for transmission via the transmitter component 1272.

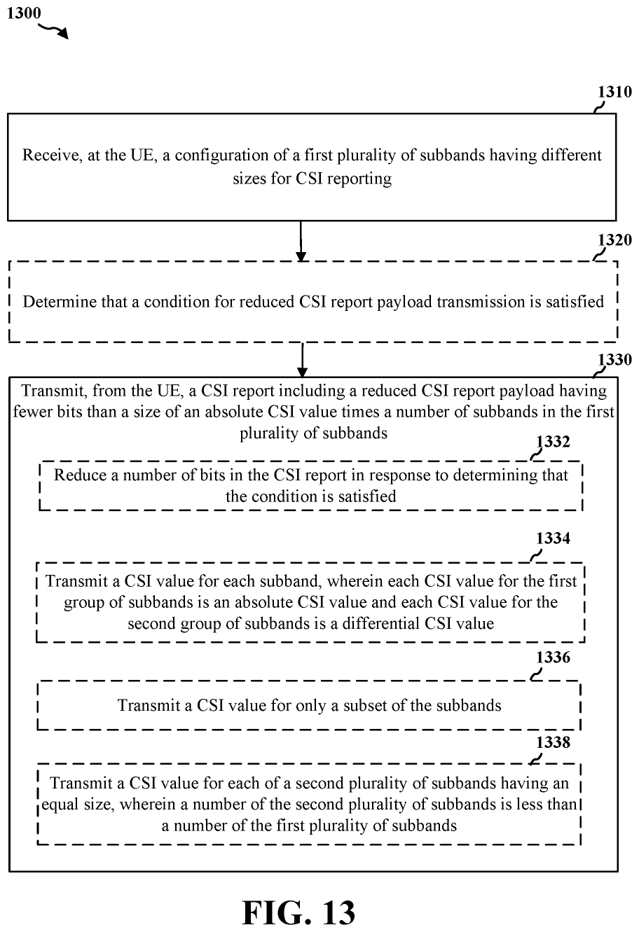

FIG. 13 is a flowchart of an example method 1300 for a UE to transmit a CSI report with a reduced CSI report payload for subbands with different sizes. The method 1300 may be performed by a UE (such as the UE 104, which may include the memory 360 and which may be the entire UE 104 or a component of the UE 104 such as the CSI component 140, Tx processor 368, the Rx processor 356, or the controller/processor 359). The method 1300 may be performed by the CSI component 140 in communication with the CSI configuration component 120 of the base station 102. Optional blocks are shown with dashed lines.

At block 1310, the method 1300 includes receiving at the UE, a configuration of a first plurality of subbands having different sizes for CSI reporting. In some implementations, for example, the UE 104, the Rx processor 356, or the controller/processor 359 may execute the CSI component 140 or the subband configuration component 142 to receive at the UE 104, a configuration 1030 of a first plurality of subbands 610 having different sizes for CSI reporting. In some implementations, the configuration 1030 is for a bandwidth part 520 configured for subband full duplexing with an uplink subband 610e. A size of the subbands 610 in the first plurality of subbands decreases closer in frequency to the uplink subband 610e. Accordingly, the UE 104, the Rx processor 356, or the controller/processor 359 executing the CSI component 140 or the subband configuration component 142 may provide means for receiving, at the UE, a configuration of a first plurality of subbands having different sizes for CSI reporting.

At block 1320, the method 1300 may optionally include determining that a condition for reduced CSI report payload transmission is satisfied. In some implementations, for example, the UE 104, the Rx processor 356, or the controller/processor 359 may execute the CSI component 140 or the condition component 144 to determine that a condition 1034 for reduced CSI report payload transmission is satisfied. In some implementations, the condition is that a PUCCH resource size is insufficient to transmit a full CSI report payload having a size of the absolute CSI value times the number of the subbands in the first plurality of subbands. In some implementations, the condition is based on a transmit power of the UE. Accordingly, the UE 104, the Rx processor 356, or the controller/processor 359 executing the CSI component 140 or condition component 144 may provide means for determining that a condition for reduced CSI report payload transmission is satisfied.

At block 1330, the method 1300 includes transmitting, from the UE, a reduced CSI report payload having fewer bits than a size of an absolute CSI value times a number of subbands in the first plurality of subbands. In some implementations, for example, the UE 104, the Tx processor 368, or the controller/processor 359 may execute the CSI component 140 and/or the CSI reporting component 146 may transmit, from the UE 104, a reduced CSI report payload 740, 840, 940 having fewer bits than a size of an absolute CSI value times a number of subbands in the first plurality of subbands (e.g., the full CSI report payload 710). In some implementations, the CSI value is a CQI value. In some implementations, the CSI value is a PMI value.

In some implementations, at sub-block 1332, the block 1330 may optionally include reducing a number of bits in the CSI report in response to determining that the condition 1034 is satisfied. For example, the sub-block 1332 may be performed in response to the optional block 1320. The CSI reporting component 146 may reduce the number of bits using differential values as described with respect to FIG. 7, a subset of the subbands as described with respect to FIG. 8, or a fallback subband configuration as described with respect to FIG. 9.

In some implementations, at sub-block 1334, the block 1330 may optionally include transmitting a CSI value for each subband, wherein each CSI value for the first group of subbands 722 is an absolute CSI value and each CSI value for the second group of subbands 724 is a differential CSI value.

In some implementations, at sub-block 1336, the block 1330 may optionally include transmitting a CSI value for only a subset 810 of the subbands 610. For example, the CSI reporting component 146 may drop subbands that are not in the subset 810 (e.g., subbands 610b, 610d, 610g, and 610i). In some implementations, the configuration includes a bitmap indicating which subbands to include in the subset 810 of the subbands. In some implementations, the subset 810 of the subbands is based on a configured or pre-defined pattern.

In some implementations, at sub-block 1338, the block 1330 may optionally include transmitting a CSI value for each of a second plurality of subbands 510 having an equal size, wherein a number of the second plurality of subbands 510 is less than a number of the first plurality of subbands 610. For example, the first subband configuration 1030 may configure 8 subbands for CSI reporting in the first plurality of subbands 610, and the fallback subband configuration 910 may configure 6 subbands for CSI reporting in the second plurality of subbands 510.

In view of the foregoing, the UE 104, the Tx processor 368, or the controller/processor 359 executing the CSI component 140 or the CSI reporting component 146 may provide means for transmitting, from the UE, a reduced CSI report payload having fewer bits than a size of an absolute CSI value times a number of subbands in the first plurality of subbands.

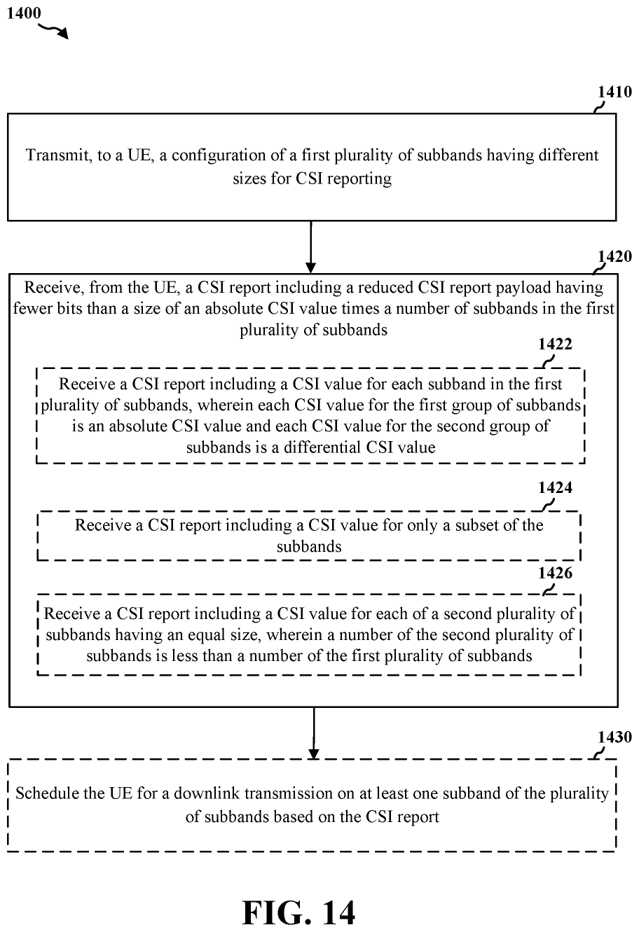

FIG. 14 a flowchart of an example method 1400 for a base station to receive a CSI report from a UE with a reduced CSI report payload for subbands with different sizes. The method 1400 may be performed by a base station (such as the base station 102, which may include the memory 376 and which may be the entire base station 102 or a component of the base station 102 such as the CSI configuration component 120, Tx processor 316, the Rx processor 370, or the controller/processor 375). The method 1400 may be performed by the CSI configuration component 120 in communication with the CSI component 140 of the first UE 104. Optional blocks are shown with dashed lines.

At block 1410, the method 1400 includes transmitting, to a UE, a configuration of a first plurality of subbands having different sizes for CSI reporting. In some implementations, for example, the base station 102, Tx processor 316, or the controller/processor 375 may execute the CSI configuration component 120 or the subband configuration component 122 to transmit, to a UE 104, a configuration 1022 of a first plurality of subbands 610 having different sizes for CSI reporting. Accordingly, the base station 102, Tx processor 316, or the controller/processor 375 executing the CSI configuration component 120 or the subband configuration component 122 may provide means for transmitting, to a UE, a configuration of a first plurality of subbands having different sizes for CSI reporting.

At block 1420, the method 1400 includes receiving, from the UE, a CSI report including a reduced CSI report payload having fewer bits than a size of an absolute CSI value times a number of subbands in the first plurality of subbands. In some implementations, for example, the base station 102, the Rx processor 370, or the controller/processor 375 may execute the CSI configuration component 120 or the CSI Rx component 124 to receive, from the UE, a reduced CSI report payload having fewer bits than a size of an absolute CSI value times a number of subbands in the first plurality of subbands.

In some implementations, at sub-block 1422, the block 1420 may optionally include receiving the CSI report 1060 including a CSI value for each subband in the first plurality of subbands. The configuration 1022 may include a first group of subbands 722 having a size greater than or equal to a threshold 720 and a second group of subbands 724 having a size less than the threshold 720. For instance, the threshold may be a number of resource blocks or a frequency range. Each CSI value for the first group of subbands 722 is an absolute CSI value and each CSI value for the second group of subbands 724 is a differential CSI value. The second group of subbands 724 may be located closer in frequency to an uplink subband 610e than the first group of subbands 722.

In some implementations, at sub-block 1424, the block 1420 may optionally include receiving the CSI report 1060 including a CSI value for only a subset 810 of the subbands 610. For example, subbands that are not in the subset 810 (e.g., subbands 610b, 610d, 610g, and 610i) may have been dropped from the CSI report 1060.

In some implementations, at sub-block 1426, the block 1330 may optionally include receiving a CSI report including a CSI value for each of a second plurality of subbands 510 having an equal size, wherein a number of the second plurality of subbands 510 is less than a number of the first plurality of subbands 610. For example, the first subband configuration 1030 may configure 8 subbands for CSI reporting in the first plurality of subbands 610, and the fallback subband configuration 910 may configure 6 subbands for CSI reporting in the second plurality of subbands 510.

In view of the foregoing, the base station 102, Rx processor 370, or the controller/processor 375 executing the CSI configuration component 120 or the CSI Rx component 124 may provide means for receiving, from the UE, a reduced CSI report payload having fewer bits than a size of an absolute CSI value times a number of subbands in the first plurality of subbands.

At block 1430, the method 1400 may optionally include scheduling the UE for a downlink transmission on at least one subband of the plurality of subbands based on the CSI report. In some implementations, for example, the base station 102, Tx processor 316, or the controller/processor 375 may execute the CSI configuration component 120 or the scheduling component 126 to schedule the UE 104 for a downlink transmission on at least one subband 610 of the plurality of subbands based on the CSI report 1060. Accordingly, the base station 102, Tx processor 316, or the controller/processor 375 executing the CSI configuration component 120 or the scheduling component 126 may provide means for scheduling the UE for a downlink transmission on at least one subband of the plurality of subbands based on the CSI report.

The following provides an overview of aspects of the present disclosure:

Clause 1. A method of wireless communication at a user equipment (UE), comprising: receiving, at the UE, a configuration of a first plurality of subbands having different sizes for channel state information (CSI) reporting; and transmitting, from the UE, a reduced CSI report payload including a plurality of CSI values, the reduced CSI report payload having fewer bits than a size of an absolute CSI value times a number of subbands in the first plurality of subbands.

Clause 2. The method of clause 1, wherein the configuration includes a first group of subbands having a size greater than or equal to a threshold and a second group of subbands having a size less than the threshold, wherein transmitting the reduced CSI report payload comprises: transmitting a CSI report including a CSI value for each subband, wherein each CSI value for the first group of subbands is an absolute CSI value and each CSI value for the second group of subbands is a differential CSI value.

Clause 3. The method of clause 2, wherein the threshold is a number of resource blocks or a frequency range.

Clause 4. The method of clause 2 or 3, wherein the second group of subbands are located closer in frequency to an uplink subband than the first group of subbands.

Clause 5. The method of any of clauses 1-4, wherein the configuration includes a condition for reduced CSI report payload transmission, wherein transmitting the CSI report comprises reducing a number of bits in the CSI report in response to determining that the condition is satisfied.

Clause 6. The method of clause 5, wherein the condition is that a physical uplink control channel (PUCCH) resource size is insufficient to transmit a full CSI report payload having a size of the absolute CSI value times the number of the subbands in the first plurality of subbands.

Clause 7. The method of clause 5, wherein the condition is based on a transmit power of the UE.

Clause 8. The method of any of clauses 5-7, wherein transmitting the CSI report comprises transmitting a CSI value for only a subset of the subbands.

Clause 9. The method of clause 8, wherein the configuration includes a bitmap indicating which subbands to include in the subset of the subbands.

Clause 10. The method of clause 8, wherein the subset of the subbands is based on a configured or pre-defined pattern.

Clause 11. The method of clause 5, wherein transmitting the CSI report comprises transmitting a CSI value for each of a second plurality of subbands having an equal size, wherein a number of the second plurality of subbands is less than a number of the first plurality of subbands.

Clause 12. The method of any of clauses 1-11, wherein the plurality of CSI values are channel quality indicator (CQI) values.

Clause 13. The method of any of clauses 1-11, wherein the plurality of CSI values are precoding matrix indicator (PMI) values.

Clause 14. The method of any of clauses 1-13, wherein the configuration is for a bandwidth part configured for subband full duplexing with an uplink subband, wherein a size of the subbands in the first plurality of subbands decreases closer in frequency to the uplink subband.

Clause 15. A method of wireless communication at a network node, comprising: transmitting, to a user equipment (UE), a configuration of a first plurality of subbands having different sizes for channel state information (CSI) reporting; and receiving, from the UE, a reduced CSI report payload having fewer bits than a size of an absolute CSI value times a number of subbands in the first plurality of subbands.

Clause 16. The method of clause 15, wherein the configuration includes a first group of subbands having a size greater than or equal to a threshold and a second group of subbands having a size less than the threshold, wherein receiving the CSI report comprises: receiving a CSI report including a CSI value for each subband, wherein each CSI value for the first group of subbands is an absolute CSI value and each CSI value for the second group of subbands is a differential CSI value.

Clause 17. The method of clause 16, wherein the threshold is a number of resource blocks or a frequency range.

Clause 18. The method of clause 16 or 17, wherein the second group of subbands are located closer in frequency to an uplink subband than the first group of subbands.

Clause 19. The method of any of clauses 15-18, wherein the configuration includes a condition for reduced CSI report payload transmission.

Clause 20. The method of clause 19, wherein the condition is that a physical uplink control channel (PUCCH) resource size is insufficient to transmit the CSI report having a size of the absolute CSI value times the number of the subbands in the first plurality of subbands.

Clause 21. The method of clause 19, wherein the condition is based on a transmit power of the UE.

Clause 22. The method of any of clauses 19-21, wherein receiving the reduced CSI report payload comprises receiving a CSI value for only a subset of the subbands, wherein the CSI value for other subbands is dropped.

Clause 23. The method of clause 22, wherein the configuration includes a bitmap indicating for which subbands to include the CSI value in the CSI report.

Clause 24. The method of clause 22, wherein the subset of the subbands is based on a configured or pre-defined pattern.

Clause 25. The method of clause 19, wherein receiving the CSI report comprises receiving a CSI value for each of a second plurality of subbands having an equal size, wherein a number of the second plurality of subbands is less than a number of the first plurality of subbands.

Clause 26. The method of any of clauses 15-25, wherein the plurality of CSI values are channel quality indicator (CQI) values or precoding matrix indicator (PMI) values.

Clause 27. The method of any of clauses 15-26, wherein the configuration is for a bandwidth part configured for subband full duplexing with an uplink subband, wherein a size of the subbands in the first plurality of subbands decreases closer in frequency to the uplink subband.

Clause 28. The method of any of clauses 15-27, further comprising scheduling the UE for a downlink transmission on at least one subband of the plurality of subbands based on the CSI report.

Clause 29. An apparatus for wireless communication, comprising: a transceiver; a memory storing computer-executable instructions; and a processor coupled with the transceiver and the memory and configured to execute the computer-executable instructions to cause the apparatus to: receive, at a user equipment (UE), a configuration of a first plurality of subbands having different sizes for channel state information (CSI) reporting; and transmit, from the UE, a reduced CSI report payload including a plurality of CSI values, the reduced CSI report payload having fewer bits than a size of an absolute CSI value times a number of subbands in the first plurality of subbands.

Clause 30. An apparatus for wireless communication, comprising: a transceiver; a memory storing computer-executable instructions; and a processor coupled with the transceiver and the memory and configured to execute the computer-executable instructions to cause the apparatus to: transmit, to a UE, a configuration of a first plurality of subbands having different sizes for channel state information (CSI) reporting; and receive, from the UE, a reduced CSI report payload having fewer bits than a size of an absolute CSI value times a number of subbands in the first plurality of subbands.

Clause 31: An apparatus for wireless communication at a UE, comprising: a transceiver; a memory storing computer-executable instructions; and a processor coupled with the transceiver and the memory and configured to execute the computer-executable instructions to perform the method of any of clauses 1-14.

Clause 32: An apparatus for wireless communication at a base station, comprising: a transceiver; a memory storing computer-executable instructions; and a processor coupled with the transceiver and the memory and configured to execute the computer-executable instructions to perform the method of any of clauses 15-28.

Clause 33: An apparatus for wireless communication, comprising: means for performing the method of any of clauses 1-14.

Clause 34: An apparatus for wireless communication, comprising: means for performing the method of any of clauses 15-28.

Clause 35: A non-transitory computer-readable medium storing computer executable code, the code when executed by a processor causes the processor to perform the method of any of clauses 1-14.

Clause 36: A non-transitory computer-readable medium storing computer executable code, the code when executed by a processor causes the processor to perform the method of any of clauses 15-28.

Clause 37. A method of wireless communication for a user equipment (UE), comprising: receiving a configuration of subbands of different sizes for channel state information (CSI) reporting including a first group of subbands having a size greater than or equal to a threshold and a second group of subbands having a size less than the threshold; and transmitting a CSI value for each subband, each CSI value for the first group of subbands being an absolute CSI value and each CSI value for the second group of subbands being a differential CQI value.

Clause 38. A method of wireless communication for a user equipment (UE), comprising: receiving a configuration of a plurality of subbands of different sizes for channel state information (CSI) reporting; measuring a CSI value for each of the plurality of subbands; determining that a configured condition for reduced CSI reporting is satisfied; and transmitting a CSI report including the CSI value for a subset of the subbands.

Clause 39. A method of wireless communication for a user equipment (UE), comprising: receiving a configuration of a first plurality of subbands of different sizes for channel state information (CSI) reporting; measuring a CSI value for each of the first plurality of subbands; determining that a configured condition for reduced CSI reporting is satisfied; and transmitting a CSI report including a CSI value for each of a second plurality of subbands having an equal size, wherein a number of the second plurality of subbands is less than a number of the first plurality of subbands.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication at a user equipment (UE), comprising:
receiving, at the UE, a configuration of a first plurality of subbands having different sizes for channel state information (CSI) reporting; and
transmitting, from the UE, a reduced CSI report payload including a plurality of CSI values, the reduced CSI report payload having fewer bits than a size of an absolute CSI value times a number of subbands in the first plurality of subbands.

2. The method of claim 1, wherein the configuration includes a first group of subbands having a size greater than or equal to a threshold and a second group of subbands having a size less than the threshold, wherein transmitting the reduced CSI report payload comprises:
transmitting a CSI report including a CSI value for each subband, wherein each CSI value for the first group of subbands is an absolute CSI value and each CSI value for the second group of subbands is a differential CSI value.

3. The method of claim 2, wherein the threshold is a number of resource blocks or a frequency range.

4. The method of claim 2, wherein the second group of subbands are located closer in frequency to an uplink subband than the first group of subbands.

5. The method of claim 1, wherein the configuration includes a condition for reduced CSI report payload transmission, wherein transmitting the CSI report comprises reducing a number of bits in the CSI report in response to determining that the condition is satisfied.

6. The method of claim 5, wherein the condition is that a physical uplink control channel (PUCCH) resource size is insufficient to transmit a full CSI report payload having a size of the absolute CSI value times the number of the subbands in the first plurality of subbands.

7. The method of claim 5, wherein the condition is based on a transmit power of the UE.

8. The method of claim 5, wherein transmitting the CSI report comprises transmitting a CSI value for only a subset of the subbands.

9. The method of claim 8, wherein the configuration includes a bitmap indicating which subbands to include in the subset of the subbands.

10. The method of claim 8, wherein the subset of the subbands is based on a configured or pre-defined pattern.

11. The method of claim 5, wherein transmitting the CSI report comprises transmitting a CSI value for each of a second plurality of subbands having an equal size, wherein a number of the second plurality of subbands is less than a number of the first plurality of subbands.

12. The method of claim 1, wherein the plurality of CSI values are channel quality indicator (CQI) values.

13. The method of claim 1, wherein the plurality of CSI values are precoding matrix indicator (PMI) values.

14. The method of claim 1, wherein the configuration is for a bandwidth part configured for subband full duplexing with an uplink subband, wherein a size of the subbands in the first plurality of subbands decreases closer in frequency to the uplink subband.

15. A method of wireless communication at a network node, comprising:
transmitting, to a user equipment (UE), a configuration of a first plurality of subbands having different sizes for channel state information (CSI) reporting; and
receiving, from the UE, a reduced CSI report payload having fewer bits than a size of an absolute CSI value times a number of subbands in the first plurality of subbands.

16. The method of claim 15, wherein the configuration includes a first group of subbands having a size greater than or equal to a threshold and a second group of subbands having a size less than the threshold, wherein receiving the CSI report comprises:
receiving a CSI report including a CSI value for each subband, wherein each CSI value for the first group of subbands is an absolute CSI value and each CSI value for the second group of subbands is a differential CSI value.

17. The method of claim 16, wherein the threshold is a number of resource blocks or a frequency range.

18. The method of claim 16, wherein the second group of subbands are located closer in frequency to an uplink subband than the first group of subbands.

19. The method of claim 15, wherein the configuration includes a condition for reduced CSI report payload transmission.

20. The method of claim 19, wherein the condition is that a physical uplink control channel (PUCCH) resource size is insufficient to transmit the CSI report having a size of the absolute CSI value times the number of the subbands in the first plurality of subbands.

21. The method of claim 19, wherein the condition is based on a transmit power of the UE.

22. The method of claim 19, wherein receiving the reduced CSI report payload comprises receiving a CSI value for only a subset of the subbands, wherein the CSI value for other subbands is dropped.

23. The method of claim 22, wherein the configuration includes a bitmap indicating for which subbands to include the CSI value in the CSI report.

24. The method of claim 22, wherein the subset of the subbands is based on a configured or pre-defined pattern.

25. The method of claim 19, wherein receiving the CSI report comprises receiving a CSI value for each of a second plurality of subbands having an equal size, wherein a number of the second plurality of subbands is less than a number of the first plurality of subbands.

26. The method of claim 15, wherein the plurality of CSI values are channel quality indicator (CQI) values or precoding matrix indicator (PMI) values.

27. The method of claim 15, wherein the configuration is for a bandwidth part configured for subband full duplexing with an uplink subband, wherein a size of the subbands in the first plurality of subbands decreases closer in frequency to the uplink subband.

28. The method of claim 15, further comprising scheduling the UE for a downlink transmission on at least one subband of the plurality of subbands based on the CSI report.

29. An apparatus for wireless communication, comprising:
a transceiver;
a memory storing computer-executable instructions; and
a processor coupled with the transceiver and the memory and configured to execute the computer-executable instructions to cause the apparatus to:
receive, at a user equipment (UE), a configuration of a first plurality of subbands having different sizes for channel state information (CSI) reporting; and
transmit, from the UE, a reduced CSI report payload including a plurality of CSI values, the reduced CSI report payload having fewer bits than a size of an absolute CSI value times a number of subbands in the first plurality of subbands.

30. An apparatus for wireless communication, comprising:
a transceiver;
a memory storing computer-executable instructions; and
a processor coupled with the transceiver and the memory and configured to execute the computer-executable instructions to cause the apparatus to:
transmit, to a UE, a configuration of a first plurality of subbands having different sizes for channel state information (CSI) reporting; and
receive, from the UE, a reduced CSI report payload having fewer bits than a size of an absolute CSI value times a number of subbands in the first plurality of subbands.
